(19) United States
(12) Patent Application Publication
(10) Pub. No.: US 2018/0322125 A1
(43) Pub. Date: Nov. 8, 2018

(54) ITEMSET DETERMINING METHOD AND APPARATUS, PROCESSING DEVICE, AND STORAGE MEDIUM

(71) Applicant: TENCENT TECHNOLOGY (SHENZHEN) COMPANY LIMITED, Shenzhen (CN)

(72) Inventors: Chun-Wei LIN, Shenzhen (CN); Wensheng GAN, Shenzhen (CN); Lei XIAO, Shenzhen (CN); Wei CHEN, Shenzhen (CN)

(73) Assignee: TENCENT TECHNOLOGY (SHENZHEN) COMPANY LIMITED, Shenzhen (CN)

(21) Appl. No.: 16/023,611

(22) Filed: Jun. 29, 2018

Related U.S. Application Data
(63) Continuation of application No. PCT/CN2017/102908, filed on Sep. 22, 2017.

(30) Foreign Application Priority Data
Sep. 23, 2016 (CN) 201610847309.3

(51) Int. Cl. G06F 17/30

(52) U.S. Cl. CPC G06F 17/3053

(57) ABSTRACT

An itemset determining method is described. At least one target transaction in a database is identified based on a candidate itemset. A respective first time validity value corresponding to each one of the at least one target transaction is determined. A second time validity value of the candidate itemset is determined according to a summation of the respective one or more first time validity values corresponding to the at least one target transaction. An expected support value of the candidate itemset is determined according to a summation of the respective one or more itemset probabilities corresponding to the candidate itemset in the at least one target transaction. The candidate itemset is determined as having a status of a high expected weighted itemset within a valid time based on the second time validity value and an expected weighted support value of the candidate itemset.

### RELATED APPLICATION

This application is a continuation of International Application No. PCT/CN2017/102908, filed on Sep. 22, 2017, which claims priority to Chinese Patent Application No. 201610847309.3, filed with the Chinese Patent Office on Sep. 23, 2016, and entitled “METHOD, APPARATUS, AND PROCESSING DEVICE FOR MINING HIGH EXPECTED WEIGHTED ITEMSET WITHIN VALID TIME.” The entire disclosures of the prior applications are hereby incorporated herein by reference in their entirely.

### FIELD OF THE TECHNOLOGY

The present disclosure relates to the field of data processing technologies, and specifically, to an itemset determining method and apparatus, a processing device, and a storage medium.

### BACKGROUND OF THE DISCLOSURE

Currently, during recommendation of content (for example, a web page, news, or a commodity) in which a user is interested and mining of hot high-frequency words that are frequently searched, generally, itemsets having a status of a high expected weighted itemset (HEWI) within a valid time are to be mined from a database. The HEWI within a valid time is an itemset that has high timeliness and that is frequently expected in the database and represents a recent high expected weighted itemset (RHEWI) in the database. It should be noted that, the database usually records at least one transaction such as trade or news. Each transaction includes at least one data item. To represent an association rule between data items in the database, at least one data item gathers to form an itemset.

Currently, generally, an itemset that is an HEWI within a valid time is mined from the database base mining algorithms based on weight factors. Generally, these algorithms performs itemset mining simply based on the weight factors and performs itemset mining on only databases that store accurate data. However, during actual mining, types of data vary, and data in the database usually has uncertainty (that is, the database usually stores uncertain data, e.g., a data item that is associated with a probability of occurrence). When an itemset that is an HEWI within a valid time is mined from a database that stores uncertain data (uncertain database for short), the current mining algorithms based on weight factors are inapplicable. For example, a database stores trade records in the past three years, data items in the database correspond to different commodities. A weight corresponding to a notebook is 0.4, a weight corresponding to bread is 0.001, and a weight corresponding to a fan is 0.05. It can be learned that, weights corresponding to different data items are different. If itemsets that have a HEWI status in the past six months need to be mined out, the uncertain database cannot be mined based on the mining algorithms based on weight factors. As such, an itemset that is a HEWI within a valid time cannot be mined out. If a data item for information pushing is determined based on the current mining algorithm, accuracy and timeliness of the data item for information pushing is less than satisfactory.

### SUMMARY

In view of this, embodiments of the present disclosure provide an itemset determining method and apparatus, a processing device, and a storage medium, to determine an HEWI within a valid time from a database.

Aspects of the disclosure provide a method for determining an HEWI within a valid time. A processor determines at least one target transaction corresponding to a candidate itemset, the target transaction corresponding to the candidate itemset being a transaction that comprises all data items of the candidate itemset in a database. The processor determines a time validity value of the candidate itemset in each target transaction based on a predefined time-decay factor, and adds the time validity values of the candidate itemset in the target transactions, to determine a time validity value of the candidate itemset in the database. The processor determines an itemset probability of the candidate itemset in each target transaction, and adds the itemset probabilities of the candidate itemset in the target transactions, to determine an expected support (expSup) of the candidate itemset. The processor multiplies the expSup of the candidate itemset by an itemset weight of the candidate itemset, to determine an expected weighted support (expWSup) of the candidate itemset, the itemset weight of the candidate itemset being determined based on predefined weights of the data items in the candidate itemset. Also, the processor determines that the candidate itemset is an HEWI within a valid time if the time validity value of the candidate itemset in the database is not less than a predefined minimum time validity threshold and the expWSup of the candidate itemset is not less than a product of a predefined minimum expected weighted threshold and a total quantity of transactions in the database.

Aspects of the disclosure provide an apparatus for determining an HEWI within a valid time, including a processor and a memory. The memory stores the following processor-executable instruction modules, such as a target transaction determining module, a time validity value of an itemset in a transaction determining module, a time validity value of an itemset determining module, an itemset probability determining module, an expSup determining module, an expWSup determining module, and an HEWI determining module. The target transaction determining module is configured to determine at least one target transaction corresponding to a candidate itemset, the target transaction corresponding to the candidate itemset being a transaction that comprises all data items of the candidate itemset in a database. The time validity value of an itemset in a transaction determining module is configured to determine a time validity value of the candidate itemset in each target transaction based on a predefined time-decay factor. The time validity value of an itemset determining module is configured to add the time validity values of the candidate itemset in the target transactions, to determine a time validity value of the candidate itemset in the database. The itemset probability determining module is configured to determine an itemset probability of the candidate itemset in each target transaction. The expSup determining module is configured to add the itemset probabilities of the candidate itemset in the target transactions, to determine an expSup of the candidate itemset. The expWSup determining module is configured to multiply the expSup of the candidate itemset by an itemset weight of the candidate itemset, and to determine an expWSup of the candidate itemset, the itemset weight of the candidate itemset being determined based on predefined weights of the data items in the candidate itemset. The HEWI determining module is configured to determine that the candidate itemset is an HEWI within a valid time if the time validity value of the candidate itemset in the database is not less than a predefined minimum time validity threshold and the expWSup of the candidate itemset is not less than a product of a predefined minimum expected weighted threshold and a total quantity of transactions in the database.

An embodiment of the present disclosure further provides a processing device, including the foregoing apparatus for determining an HEWI within a valid time.

An embodiment of the present disclosure further provides a non-volatile storage medium, storing a processor-readable instruction. When the instruction is executed, the processor is caused to perform the foregoing method for determining an HEWI within a valid time.

Aspects of the disclosure provide an itemset determining method. At least one target transaction in a database is identified based on a candidate itemset in the database, the at least one target transaction including each data item in the candidate itemset, and each transaction in the database including at least one data item and an occurrence probability of the data item. A respective first time validity value corresponding to each one of the at least one target transaction is determined based on the candidate itemset and a predefined time-decay factor. A second time validity value of the candidate itemset is determined according to a summation of the respective one or more first time validity values corresponding to the at least one target transaction. A respective itemset probability corresponding to the candidate itemset in each one of the at least one target transaction is determined. An expected support value of the candidate itemset is determined according to a summation of the respective one or more itemset probabilities. The expected support value of the candidate itemset is multiplied, by a processor, by an itemset weight of the candidate itemset, to determine an expected weighted support value of the candidate itemset, the itemset weight of the candidate itemset being determined based on one or more predefined weights of one or more data items in the candidate itemset. The candidate itemset is determined by the processor as having a status of a high expected weighted itemset within a valid time when the second time validity value of the candidate itemset is not less than a predefined minimum time validity threshold and the expected weighted support value of the candidate itemset is not less than a product of a predefined minimum expected weighted threshold and a total quantity of transactions in the database. A data processing is performed on the candidate itemset for output when the candidate itemset is determined as having the status of the high expected weighted itemset within the valid time.

Aspects of the disclosure provide an itemset determining apparatus that includes a memory and a processor. The memory stores processor-executable instructions. The processor is coupled with the memory and executes the processor-executable instructions to perform at least the operations described herein. For example, the processor identifies at least one target transaction in a database based on a candidate itemset in the database, the at least one target transaction including each data item in the candidate itemset, and each transaction in the database including at least one data item and an occurrence probability of the data item. The processor determines a respective first time validity value corresponding to each one of the at least one target transaction based on the candidate itemset and a predefined time-decay factor. The processor determines a second time validity value of the candidate itemset according to a summation of the respective one or more first time validity values corresponding to the at least one target transaction. The processor determines a respective itemset probability corresponding to the candidate itemset in each one of the at least one target transaction. The processor also determines an expected support value of the candidate itemset according to a summation of the respective one or more itemset probabilities. The processor multiplies the expected support value of the candidate itemset by an itemset weight of the candidate itemset, to determine an expected weighted support value of the candidate itemset, the itemset weight of the candidate itemset being determined based on one or more predefined weights of one or more data items in the candidate itemset. The processor determines the candidate itemset as having a status of a high expected weighted itemset within a valid time when the second time validity value of the candidate itemset is not less than a predefined minimum time validity threshold and the expected weighted support value of the candidate itemset is not less than a product of a predefined minimum expected weighted threshold and a total quantity of transactions in the database. The processor performs a data processing on the candidate itemset for output when the candidate itemset is determined as having the status of the high expected weighted itemset within the valid time.

Aspects of the disclosure provide a non-transitory computer-readable storage medium storing computer-readable instructions, the computer-readable instructions, when executed by a processor, causing the processor to perform at least the operations described herein. For example, at least one target transaction in a database is identified based on a candidate helmet in the database, the at least one target transaction including every data item in the candidate itemset, and each transaction in the database including at least one data item and an occurrence probability of the data item. A respective first time validity value corresponding to each one of the at least one target transaction is determined based on the candidate itemset and a predefined time-decay factor. A second time validity value of the candidate itemset is determined according to a summation of the respective one or more first time validity values corresponding to the at least one target transaction. A respective itemset probability corresponding to the candidate itemset in each one of the at least one target transaction is determined. An expected support value of the candidate itemset is determined according to a summation of the respective one or more itemset probabilities. The expected support value of the candidate itemset is multiplied by an itemset weight of the candidate itemset, to determine an expected weighted support value of the candidate itemset, the itemset weight of the candidate itemset being determined based on one or more predefined weights of one or more data items in the candidate itemset. The candidate itemset is determined as having a status of a high expected weighted itemset within a valid time when the second time validity value of the candidate itemset is not less than a predefined minimum time validity threshold and the expected weighted support value of the candidate itemset is not less than a product of a predefined minimum expected weighted threshold and a total quantity of transactions in the database. A data processing is performed on the candidate itemset for output when the candidate itemset is determined as having the status of the high expected weighted itemset within the valid time.

Based on the foregoing technical solutions, in the embodiments of the present disclosure, the weight of each data item is determined by using the predefined time-decay factor, a minimum weighted support threshold, and a minimum rencency threshold, and the time validity value of the candidate itemset in the database and the expWSup of the candidate itemset are calculated. Therefore, the candidate itemset is determined as the HEWI within a valid time when it is determined that the time validity value of the candidate itemset in the database is not less than a predefined minimum time validity threshold and the expWSup of the candidate itemset is not less than a product of a predefined minimum expected weighted threshold and a total quantity of transactions in the database, thereby determining an HEWI. In the method for determining an HEWI within a valid time according to the embodiments of the present disclosure, considering that internal uncertainty leads to problems such as a inaccurate determined result and poor timeliness, the HEWI within a valid time is determined in the database based on multiple measurement standards such as the time-decay factor, the minimum rencency threshold, and a minimum expWSup. Determining of an HEWI within a valid time is enabled to be applicable to a database. In addition, accuracy, timeliness of a determining result, and determining efficiency are improved. An item is selected from the HEWI within a valid time to be recommended to a user terminal, enabling pushing of information to have accuracy and timeliness.

### BRIEF DESCRIPTION OF THE DRAWINGS

To describe the technical solutions in the embodiments of the present disclosure more clearly, the following briefly introduces the accompanying drawings required for describing the embodiments. The accompanying drawings in the following description show merely the embodiments of the present disclosure, and a person of ordinary skill in the art may still derive other drawings from these accompanying, drawings.

FIG. 1 is a schematic structural diagram of an application system of an itemset determining method according to an embodiment of this application;

FIG. 2 is a flowchart of an itemset determining method according to this application;

FIG. 3 is a flowchart of an itemset determining apparatus according to this application;

FIG. 4 is a schematic block diagram of a time validity value of an itemset in a transaction determining module according to this application; and

FIG. 5 is a schematic block diagram of hardware of a processing device according to this application.

### DESCRIPTION OF EMBODIMENTS

For ease of understanding technical solutions provided by embodiments of the present disclosure, the following describes some definition concepts.

1. A transaction: a record in an uncertain database. For example, a trade record of a commodity is recorded in an uncertain database of a trade type, and each transaction may correspond to a trade record of the commodity.

2. A data item: an information item recorded in a transaction. A transaction includes at least one data item. At least one data item and an occurrence probability of each data item may be recorded in a transaction. For example, in an uncertain database of a trade type, each transaction may include a data item of a traded commodity a trade probability (a form of the occurrence probability) of each commodity, and the like.

As shown in the following Table 1, the uncertain database of a transaction type includes 10 transactions. Each transaction indicates a trade record. Each transaction includes at least one data item of a commodity name and a trade probability of each commodity. In addition each transaction record may be distinguished by using a transaction ID (TID), and each transaction correspondingly records a transaction time.

TABLE 1

| TID | Transaction Time | Transaction (data item, probability) |
|---|---|---|
| T1 | 2015 Jan. 8, 09:10 | a: 0.3, b: 0.8, c: 1.0 |
| T2 | 2015 Jan. 9, 11:20 | d: 1.0, f: 0.5 |
| T3 | 2015 Jan. 11, 08:20 | b: 0.6, c: 0.7, d: 0.9, e: 1.0, f: 0.7 |
| T4 | 2015 Jan. 12, 09:15 | a: 0.5, c: 0.45, f: 1.0 |
| T5 | 2015 Jan. 12, 15:20 | c: 0.9, d: 1.0, e: 0.7 |
| T6 | 2015 Jan. 14, 08:30 | b: 0.7, d: 0.3 |
| T7 | 2015 Jan. 14, 15:25 | a: 0.8, b: 0.4, c: 0.9, d: 1.0, e: 0.85 |
| T8 | 2015 Jan. 15, 09:10 | c: 0.9, d: 0.5, f: 1.0 |
| T9 | 2015 Jan. 16, 08:30 | a: 0.5, e: 0.4 |
| T10 | 2015 Jan. 18, 09:00 | b: 1.0, c: 0.9, d: 0.7, e: 1.0, f: 1.0 |

As shown in Table 1, a transaction time of a transaction T1 is Jan. 9, 2015, 9:10. In the transaction T1, a trade probability of a commodity a is 0.3, a trade probability of a commodity b is 0.8, and a trade probability of a commodity c is 1.

3. An itemset: a set of at least one data item, used for representing an internal association rule of an uncertain database. A difference between a transaction and an itemset lies in that the transaction is generally a record generated, in the uncertain database, by triggering an event that actually happened, and the itemset is generally obtained by mining the uncertain database.

4. A k-itemset: a set including k data items. For example, 1-itemset may be an itemset that includes one data item, such as an itemset A that includes only a data item A, A 2-itemset may be an itemset that includes two data items, such as an itemset AB that includes data items A and B, and so on.

5. An uncertain database: a database of a data item in a transaction that has an occurrence probability. An exemplary structure of the uncertain database is shown in Table 1, For example, the uncertain database records future weather conditions, and each of the weather conditions on the database corresponds to an occurrence probability. That is, each data item in each transaction in the uncertain database corresponds to an occurrence probability.

6. A weight of data item in an uncertain database: a weight of each data item in the uncertain database. The weight of the data item may be a weight threshold defined by a user for each data item based on prior knowledge or an application background. In some examples, the weight ranges from 0 to 1, and may refer to an importance degree, a risk degree, a profit weight, a freshness degree of the data item, or the like.

For example, the uncertain database shown in Table 1 includes six data items: a, b, c, d, e, and f. Weights of the six data items are defined by the user, and a weight table is obtained. The following Table 2 shows an example of the weight table.

TABLE 2

Data item

| | a | b | c | d | e | f |
|---|---|---|---|---|---|---|
| Weight | 0.3 | 0.4 | 1.0 | 0.55 | 0.8 | 0.7 |

7. An itemset weight: the itemset weight indicates a weight of an itemset in the uncertain database, and may reflect an important degree of the itemset in the uncertain database. An itemset weight of an itemset may be obtained by dividing a gross weight of the data items in the itemset by a quantity of the data items in the itemset. A specific equation for determining an itemset weight may be as follows:

$$w ( X ) = \frac{{\sum }_{i , ∈ X} w ( {i}_{j} )}{\vert X \vert} ,$$

where X represents an itemset, [X] refers to a quantity of data items of the itemset, j is a cardinal number, iⱼ refers to a j^{th} data item in the itemset X and Σ_{i,eX}^{w(i}^{ⱼ}⁾ refers to a summation of weights of data items in the itemset X.

In some examples, a weight of an itemset in a corresponding target transaction may be equal to an itemset weight of the itemset (that is, a weight of the itemset in the uncertain database). A target transaction corresponding to an itemset is a transaction that includes all data items in the itemset.

8. A time validity value of a transaction: the time validity value of a transaction represents a recency of a transaction, used for representing time validity of the transaction. In at least one embodiment of the present disclosure, the time validity value of a transaction may be obtained based on a predefined time-decay factor, that is, a valid value that is related to time and that is obtained through calculation by using the predefined time-decay factor. A specific equation far calculating a time validity value may be as follows:

R(T_{q})=(1−δ)^{|t}^{_{current}}^{|-t}^{_{q}}, where δ∈ (0,1) is the predefined time-decay factor, R(T_{q}) is a time validity value of a transaction represents a current time, and t_{q} represents an occurrence time of the transaction T_{q}.

9. A time validity value of an itemset in a transaction: a time validity value of an itemset in a transaction represents a recency of the itemset in the transaction and may be equal to a time validity value of the transaction.

10. A time validity value of an itemset in an uncertain database: a time validity value of an itemset in the uncertain database represents a recency of the itemset in the uncertain database and may be equal to a sum of time validity values of the helmet in corresponding target transactions.

For example, for an itemset a, as shown in Table 1, target transactions corresponding to the itemset a are T1, T4, T7, and T9 (in other words, the transactions T1, T4, T7, and T9 include all data items of itemset a), and a time validity value of the itemset a in the uncertain database is: a time validity value of the itemset a in the transaction T1+a time validity value of the itemset a in the transaction T4+a time validity value of the itemset a in the transaction T7+a time validity value of the itemset a in the transaction T9.

11. An itemset probability of an itemset in a transaction: an itemset probability of an itemset in a corresponding, target transaction is a product of occurrence probabilities of data items of the itemset in the target transaction. For example, as shown in Table 1, an itemset probability of an itemset ab in a target transaction. T1 is a product of occurrence probabilities of a data item a and a data item b of the itemset ab in the transaction T1, that is, 0.3×0.8=0.24.

12. An expSup (that is, an expected support value) of an itemset: the expSup of an itemset is a sum of itemset probabilities of the itemset in corresponding target transactions. For example, for an itemset a, as shown in Table 1, target transactions corresponding to the itemset a are T1, T4, T7, and T9, and an expSup of the itemset a is a sum of itemset probabilities of the itemset a in the T1, T4, T7, and T9, that is, 0.3 (an itemset probability of the itemset a in the T1)+0.5 (an itemset probability of the itemset a in the T4)+0.8 (an itemset probability of the itemset a in the T7)+0.5 (an itemset probability of the itemset a in the T9)+2.1.

13. An expWSup (that is, an expected weighted support value) of an itemset: an expWSup of an itemset is a product of an expSup of the itemset and itemset weight of the itemset.

14. An HEWI: if an expWSup of an itemset is not less than a product of a predefined minimum expected weighted threshold and a total quantity of transactions in an uncertain database, the itemset is determined as having a status of an HEWI, or simply referred to in this disclosure as the itemset being an HEWI.

15. An HEWI within a valid time: the HEWI within a valid time represents an RHEWI. If a time validity value of an itemset in an uncertain database is not less than a predefined minimum time validity threshold and an expWSup of the itemset is not less than a product of a predefined minimum expected weighted threshold and a total quantity of transactions in the uncertain database, the itemset is determined as having a status of an HEWI within a valid time, or simply referred to in this disclosure as the itemset being an HEWI within a valid time.

16. A transaction upper bound weight (tubw): a tubw of a transaction may be equal to a maximum value in weights of data items in the transaction. For example, with reference to Table 1 and Table 2, a tubw of a transaction T1 in Table 1 is a weight corresponding to a data item with a maximum weight in the transaction T1, that is, a weight 1 of a data item c.

17. A transaction upper bound probability (tubp): a tubp of a transaction may be equal to a maximum value in occurrence probabilities of data items in the transaction. For example, with reference to Table 1, a tubp of a transaction T2 in Table 1 is an occurrence probability corresponding to a data item with a maximum occurrence probability in the transaction T2, that is, an occurrence probability 1 of a data item d.

18. A transaction upper bound weighted probability (tubwp): a tubwp of a transaction may be equal to a product of a tubw of the transaction and a tubp of the transaction.

19. A transaction accumulation upper bound weighted probability (taubwp) of an itemset: a taubwp of an itemset may be equal to a sum of wimps of target transactions corresponding to the itemset.

20. A high upper bound expected weighted itemset within a valid time: the high upper bound expected weighted itemset within a valid time represents a recent high upper bound expected weighted itemset (RHUBEWI). If a time validity value of an itemset in an uncertain database is not less than a predefined minimum time validity threshold and a taubwp of the itemset is not less than a product of a predefined minimum expected weighted threshold and a total quantity of transactions in the uncertain database, the itemset is determined as having a status of a high upper bound expected weighted itemset within a valid time, or simply referred to in this disclosure as the itemset being a high upper bound expected weighted itemset within a valid time

The following describes the technical solutions in various embodiments of the present disclosure with reference to the accompanying drawings. The described embodiments do not represent all possible embodiments of the present disclosure. All other embodiments obtained by a person of ordinary skill in the art based on the embodiments in the present disclosure shall fall within the protection scope of the present disclosure.

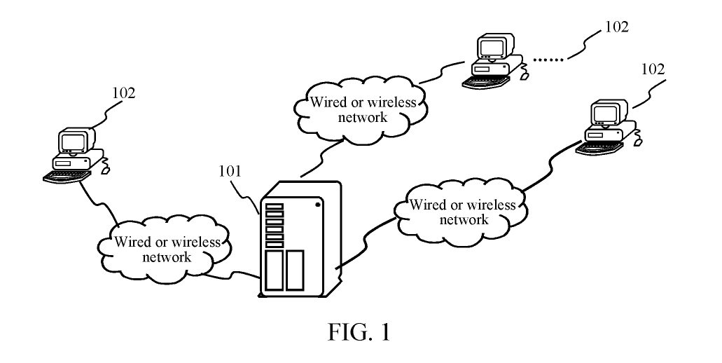

FIG. 1 is a schematic structural diagram of an application system of an itemset determining method according to an embodiment of this application. As shown in FIG. 1, FIG. 1 is a schematic structural diagram of an implementation environment related to an embodiment of this application. The system includes a server 101 and at least one terminal 102.

The terminal 102 is connected to the server 101 by using a wireless or cable network. The terminal 102 may be an electronic device such as a computer, a smartphone, or a tablet compute, and includes a processor and a display apparatus.

The server 101 may be an Internet application server, and the Internet application server may provide a backend service for an Internet application. As an application program that provides information exchange services such as voice, video, pictures, and text for a smart terminal, the Internet application has advantages such as sending voice, video, picture, and text by crossing communications carriers and operating system platforms.

The Internet application server may be configured as a server providing a service by using the Internet. The Internet application server may be a social application server, for example, a server corresponding to a social networking site such as an instant messaging server, a forum, or a microblog, or a server that can implement a service such as payment by using the Internet. A type of the Internet application server is not specifically limited to this embodiment of this application.

Certainly, the server 101 may alternatively be another server, for example, a multimedia resource sharing server. A type of the server is not specifically limited in this embodiment of this application.

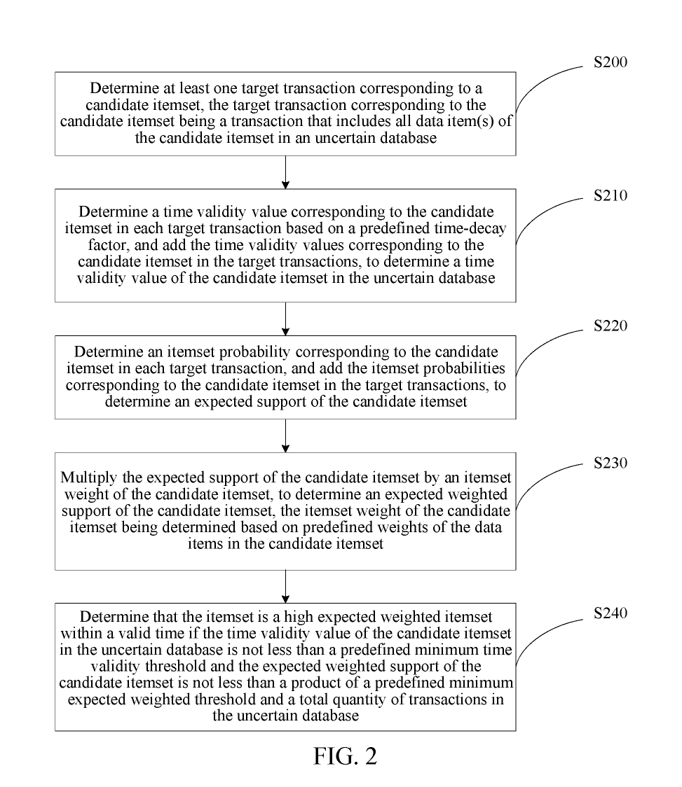

FIG. 2 is a flowchart of an itemset determining, method according to an embodiment of the present disclosure. The method may be applied to a processing device having a data processing capability, for example, a data processing server applied to a network side. In at least one embodiment of the present disclosure, an itemset is determined by using a data mining, manner. In some examples, based on different data mining scenarios, mining of an HEWI within a valid time may be performed on a device such as a computer at a user side. Referring to FIG. 1, the itemset determining method provided by this embodiment of the present disclosure may include the following steps.

Step S200: Determine at least one target transaction corresponding to a candidate itemset, the target transaction corresponding to the candidate itemset being a transaction that includes all data item(s) of the candidate itemset in an uncertain database.

In some embodiments, for each candidate itemset, in this embodiment of the present disclosure, the target transaction corresponding to the candidate itemset may be determined, and a target transaction corresponding to an itemset is a transaction that includes all data item(s) of the itemset in the uncertain database. The candidate itemset may be any itemset mined from the uncertain database, and an itemset includes at least one data item.

As shown in Table 1, if the candidate itemset is an itemset ab, target transactions corresponding to the itemset ab are transactions T1 and T7. That is, in an uncertain database shown in Table 1, only the transactions T1 and T7 include all data items a and b of the itemset ab.

In some embodiments, first, one or more 1-itemsets that each includes a data item in the database may be identified, and one or more high expected weighted 1-itemsets within a valid time is mined from the identified one or more 1-itemsets. Subsequently, an HEWI within a valid time associated with each of the one or more high expected weighted 1-itemsets within a valid time is mined accordingly.

Step S210: Determine a time validity value of the candidate itemset in each target transaction based on a predefined time-decay factor, and add the time validity values of the candidate itemset in the target transactions, to determine a time validity value of the candidate itemset in the uncertain database.

In some embodiments, the time validity value of the candidate itemset in a target transaction may be equal to a time validity value of the target transaction. A time validity value of a transaction may be determined based on the predetermined time-decay factor, a current time, and an occurrence time of the transaction.

After the time validity value of the candidate itemset in each target transaction is obtained, the time validity values of the candidate itemset in the target transactions may be added, and an adding result is used as the time validity value of the candidate itemset in the uncertain database.

Step S220: Determine an itemset probability of the candidate itemset in each target transaction, and add the itemset probabilities of the candidate itemset in the target transactions, to determine an expSup of the candidate itemset.

In some embodiments, a transaction may record at least one data item and an occurrence probability of each data item. In this embodiment of the present disclosure, after the target transaction corresponding to the candidate itemset is determined, for each target transaction, a product of occurrence probabilities of data items of the candidate itemset in the target transaction may be used as an itemset probability of the candidate itemset in the target transaction. Each target transaction is processed in such a manner, and the itemset probability of the candidate itemset in each target transaction may be obtained.

In this way, the itemset probabilities of the candidate itemset in the target transactions are added, and an adding, result is used as the expSup of the candidate itemset

Step S230: Multiply the expSup of the candidate itemset by an itemset weight of the candidate itemset, to determine an expWSup of the candidate itemset, the itemset weight of the candidate itemset being determined based on predefined weights of the data items in the candidate itemset.

In some embodiments, in this embodiment of the present disclosure, a weight table may be predefined. A weight corresponding to each data item in the uncertain database is recorded in the weight table. In this way, when the itemset weight of the candidate itemset is determined, a weight of each data item of the candidate itemset may be determined from the weight table, so that a gross weight of data items of the candidate itemset is determined, thereby obtaining the itemset weight of the candidate itemset by dividing the gross weight of data items in the candidate itemset by a quantity of the data items in the candidate itemset.

Step S240: Determine that the candidate itemset is an HEWI within a valid time if the time validity value of the candidate itemset in the uncertain database is not less than a predefined minimum time validity threshold and the expWSup of the candidate itemset is not less than a product of a predefined minimum expected weighted threshold and a total quantity of transactions in the uncertain database.

After the time validity value of the candidate helmet in the uncertain database and the expWSup of the candidate itemset are obtained, there are two conditions to determine whether the candidate itemset is the HEWI within a valid time. In some embodiments, only when the two conditions are simultaneously satisfied, the candidate itemset can be determined as the HEWI within a valid time. If any one condition is not satisfied, the candidate itemset cannot be determined as the HEWI within a valid time.

Condition 1: the time validity value of the candidate itemset in the uncertain database is not less than the predefined minimum time validity threshold.

Condition 2: the expWSup of the candidate itemset is not less than the product of the predefined minimum expected weighted threshold and the total quantity of transactions in the uncertain database.

In at least one embodiment of the present disclosure, the weight of each data item is determined by using the predefined time-decay factor, a minimum weighted support threshold, and a minimum rencency threshold, and the time validity value of the candidate itemset in the uncertain database and the expWSup of the candidate itemset are calculated. Therefore, the candidate itemset is determined as the HEWI within a valid time when it is determined that the time validity value of the candidate itemset in the uncertain database is not less than the predefined minimum time validity threshold and the expWSup of the candidate itemset is not less than the product of the predefined minimum expected weighted threshold and the total quantity of transactions in the uncertain database, thereby mining an HEWI. In the method for determining an itemset according to this embodiment of the present disclosure, considering that internal uncertainty leads to problems such as an inaccurate determining result and poor timeliness, the HEWI within a valid time is determined in the uncertain database based on multiple measurement standards such as the time-decay factor, the minimum rencency threshold, and a minimum expWSup. Determining of an HEWI within a valid time is enabled to be applicable to an uncertain database. In addition, accuracy, timeliness of an itemset determining result, and itemset determining efficiency are improved.

As a non-limiting example, if the time-decay factor is set to 0.15, the minimum expected weighted threshold is set to 15%, and the minimum time validity threshold is set to 20, with reference to Table 1 and Table 2, a mined HEWI within a valid time may he shown in the following Table 3. Apparently, specific values of the parameters herein are merely examples.

### Table 3

TABLE 3

| HEWI within a | | Time validity value of an itemset |
|---|---|---|
| valid time | expWSup | in an uncertain database |
| (c) | 5.750 | 3.7097 |
| (d) | 5.750 | 3.8954 |
| (e) | 3.160 | 3.2284 |
| (f) | 2.940 | 2.6927 |
| (bc) | 1.736 | 2.1663 |
| (cd) | 2.720 | 3.1009 |
| (ce) | 2.695 | 2.3784 |
| (cf) | 2.329 | 2.4202 |
| (de) | 2.126 | 2.3784 |
| (cde) | 2.080 | 2.3784 |

In some embodiments, the time validity value of the candidate itemset in a target transaction may be equal to a time validity value of the target transaction. In at least one embodiment of the present disclosure:, a time validity value of each target transaction may be determined based on the predefined time-decay factor, a current time, and an occurrence time of each target transaction, so that the determined time validity value of each target transaction is determined as the time validity value of the candidate itemset in each target transaction.

In some embodiments, the process of determining the time validity value of the candidate itemset in each target transaction based on the predefined time-decay factor may be implemented by using the following equation.

For each target transaction, a time validity value of a target transaction T_{q} is determined according to and equation of

R(T_{q})=(1−δ)^{|t}^{_{current}}^{|-t}^{_{q}}.

where δ∈ (0,1) is the predefined time-decay factor, R(T_{q}) is the time validity value of the target transaction T_{q}, t_{current} represents a current time, t_{q} and represents an occurrence time of the target transaction T_{q}.

In this way, the time valid value of each target transaction is determined as the time valid value of the candidate itemset in each target transaction.

In some embodiments, in this embodiment of the present disclosure, first, one or more 1-itemsets that each includes a data item in the database may be identified, and one or more high expected weighted 1-items within a valid time are mined from the identified one or more 1-itemsets (that is, recent high expected weighted 1-items, so as to obtain one or more high expected weighted 1-itemsets within a valid time (RHEWI¹ for short) and one or more high upper hound expected weighted 1-itemsets within a valid time (RHEWUBI¹ for short). In this way, RHEWUB¹s are processed one by one based on a pseudoprojection technology, and all extended itemsets that use data items (that is, RHEWUBI¹s) as prefixes are mined out. The mined extended itemsets are sequentially determined as the candidate itemsets based on a mining time. An expWSup and a time validity value of each candidate itemset are calculated, so as to mine each HEWI within a valid time.

Based on this, this embodiment of the present disclosure provides two mining models based on the pseudoprojection technology. Both of the two models are based on the projection technology. The first model is RHEWI-P, and the second model is RHEWI-PS based on ranking.

Algorithm pseudocode of the RHEWI-P model is shown in the following algorithms 1 and 2. In the following algorithms, a minimum expWSup threshold represents the predefined minimum expected weighted threshold and is represented by a parameter α; the minimum rencency threshold represents the predefined minimum time validity threshold and is represented by a parameter β; a parameter δ represents the predefined time-decay factor; and text following, the code hereinafter may be considered as text explanation and description of the code.

Algorithm 1: RHEWI-P Algorithm

```
Input: D, an uncertain database; wtable, a predefined weight table; δ,
        the time-decay threshold; α, the minimum
        expected weighted support threshold;
        β, the minimum recency threshold.
Output: The set of recent high expected weighted itemsets (RHEWIs).
//for each trade transaction T_{q} in the database D
1.  for each T_{q} ∈ D do
//calculate values of an R (T_{q}), a tubw (T_{q}), a tubp (T_{q}), and a tubwp (T_{q})
of each trade transaction T_{q},
2.  calculate R (T_{q}), tubw (T_{q}), tubp (T_{q}), tubwp (T_{q});
//for each 1-itemset iⱼ in the database D
3.  for each 1-item iⱼ ∈ D do
      //calculate values of an R (iⱼ) and a taubwp (iⱼ) of each 1-itemset iⱼ
4.  calculate R (iⱼ), taubwp (iⱼ);
//for each 1-itemset iⱼ in the database D
5.  for each 1-item iⱼ ∈ D do
    //when a 1-itemset iⱼ satisfies a condition: taubwp (iⱼ) ≥ α × |D| ∧
    R (iⱼ) ≥ β, the itemset belongs to a recent high upper bound expected
    weighted 1-itemset RHEWUBI¹; and |D| is a sum of transactions
    of the database
6.  if taubwp(iⱼ) ≥ α × |D|∧R(iⱼ) ≥ β then
      //merge the 1-itemset with a set of the RHEWUBI¹
7.  RHEWUBI¹ ← RHEWUBI¹ ∪ {iⱼ};
      //calculate a value of an expected weighted support expWSup
    (iⱼ) of the 1-itemset iⱼ
8.  calculate expWSup (iⱼ);
        //if the value of the expWSup (iⱼ) of the iⱼ is greater than or
    equal to α × |D|, the 1-itemset belongs to the RHEWI¹
9.  if expWSup(iⱼ) ≥ α × |D| then
        //merge the 1-itemset with the set of the RHEWUBI¹
10. RHEWI¹ ← RHEWI¹ ∪ {iⱼ};
//sort the set of the RHEWUBI¹ in lexicographical order, and set k = 1
11. sort RHEWUBI¹ in lexicographical order, and set k = 1;
//for each 1-itemset iⱼ in the set of the RHEWUBI¹
12. for each iⱼ∈ RHEWUBI¹ do
      //construct a projection sub-database db|iⱼ based on the 1-itemset iⱼ
13. scan D to project all related transactions within iⱼ into the sub-database
    db|iⱼ of iⱼ,
      //call a function Mining-RHEWI (iⱼ, db|iⱼ, k), and continuously
    mine, based on the projection technology, all extended itemsets that
    use data items as prefixes
14. call Mining-RHEWI(iⱼ, db|iⱼ, k);
15. return RHEWIs. //return a final set of RHEWIs (a set of one or
    more HEWIs within a valid time)
```

In the algorithm 1, the first to the fourth items represent calculation performed on related information of each 1-itemset when the database is scanned for the first time, and include calculation of the time validity value R(T_{q}) of a target transaction of each 1-itemset, calculation of the tubes (T_{q}) of a target transaction of each 1-itemset, calculation of the tulip (7) of a target transaction of each 1-itemset, the tubwp (T_{q}) of a target transaction of each 1-itemset, and the like.

Subsequently, the recency R(iⱼ) and the taubwp (iⱼ) are calculated, and the RHEWUBI¹ and the RHEWI¹ (the fifth to the tenth items) are found out.

During implementation, in at least one embodiment of the present disclosure, a ranking order of each object in the database may be determined. Each object in the database may be randomly sorted or may be sorted after calculation. Specifically, in the RHEWI-P model, as shown in the 1 item, the mined high upper bound expected weighted 1-itemsets within a valid time are arranged using a lexicographical order, in other words, the itemset is sorted based on the lexicographical order of each itemset in the set of the RHEWUBI¹. Subsequently, the RHEWI-P model iteratively calls a function Mining-RHEWI (iⱼ, db|iⱼ, k), and continuously mines, based on the projection technology, all extended itemsets that use itemsets including a data time as prefixes.

A specific operation of the Mining-RHEWI(iⱼ, db|iⱼ, k) is shown in the algorithm 2.

Algorithm 2: Mining-RHEWI(X, db|X, k)

```
Input: X, a prefix itemset; db|X; the projected database by X, a projection sub-
        database db|X based on the X itemset; k, the length of X.
Output: The set of RHEWIs with the prefix X.
//generate, according to the lexicographical order in the set of the RHEWUBI¹, a
combination of all (k+1)-itemsets using X′ as a reference and merge the
combination with a set PCk + 1. For example, if RHEWUBI¹ = {a, b, c, d, e}, and
X′ is b, PCk + 1 = {bc, bd, be}. ba is not included herein because X′ is used as a
reference and items after X′ are referred to, and ba is processed in the foregoing
combination that uses a as a reference.
1.  generate PCk+1 ← {X′|X′ = X ∪ {y} ∧ y ∈ RHEWUBI¹ ∧ y is greater than all
    items in X according to the lexicographical order};
//for each (k+1)-itemset X′ in the set PCk + 1, the following operations are performed:
2.  for each (k+1)-itemset X′ ∈ PCk + 1 do
      //if X′ is included in a T_{q} and a db|X′
3.  for each X′ ⊆ T_{q} ∧ T_{q}∈db|X′ do
        //construct a projection sub-database db|X′ based on X′
4.  obtain the projected sub-database db|X′ of X′;
        //simultaneously, calculate values of an R (T_{q}), a tubw (T_{q}), a tubp (T_{q}),
    and a tubwp (T_{q}) of each transaction.
5.  calculate R (T_{q}), tubw (T_{q}), tubp (T_{q}), tubwp (T_{q});
    //calculate values of an R (X′), a taubwp (X′), and an expSup (X′) of the
    itemset X′
6.  calculate R (X′), taubwp (X′), expSup (X′);
          //if the itemset X′ satisfies a condition taubwp (X′) ≥ α × |D| ∧ R (X′)
    ≥ β, the itemset belongs to a recent high upper bound expected weighted
    (k+1)-itemset RHEWUBI^{k+1}
7.  if taubwp (X′) ≥ α × |D|∧R (X′) ≥ β then
      //calculate a value of an expWSup (X′) of the itemset X′: expWSup (X′) =
    w (X′) × expSup (X′);
8.  calculate expWSup (X′) = w(X′) × expSup (X′);
          //if the itemset X′ satisfies a condition expWSup (X′) ≥ α × |D|, the
    itemset belongs to a recent high expected weighted (k+1)-itemset RHEWI^{k+1}
9.  if expWSup (X′) ≥ α × |D| then
10. RHEWI^{k+1} ← RHEWI^{k+1}∪X′; //merge the (k+1)-itemset X′ with the set of the
    RHEWI^{k+1}
    //merge the (k+1)-itemset X′ with the upper bound set of the RHEWUBI^{k+1}
11. RHEWUBI^{k+1} ← RHEWUBI^{k+1} ∪ X′;
    Φ//call a function Mining-RHEWI (X′, db|X′, k), and continuously mine,
    based on the projection technology, all extended itemsets that use the X′ as
    prefixes
12. call Mining-RHEWI (X′, db|X′, k +1);
RHEWIs ← [symbol]   ₖ RHEWIs ^{k+1}; //merge all (k+1)-itemsets RHEWI^{k+1} that satisfy the
condition
13. return RHEWIs with the prefix X.
```

The RHEWI-PS model and the RHEWI-P model are basically similar models, and differences therebetween are as follows.

1. In the 1 item of the algorithm 1, the RHEWI-PS model uses a ranking order that weights of items are in descending order. In this exemplary database, weights of 1-itemsets obtained through calculation are {w(a): 0.3, w(b) 0.4, w(c): 1.0, w(d): 0.55, w(e): 0.8, w(f): 0.7}. Therefore, in the present disclosure, the ranking order of the RHEWI-PS is c<e<f<d<h<a (c<e represents that a data item c is sorted before a data item e). That is, the mined high upper bound expected weighted 1-itemsets within a valid time are sorted in ascending order. Projection hereinafter is operated by the database. First, the foregoing ranking is performed on each item in each transaction, and then the projection operation is performed.

2. Specific operations are different in the Mining-RHEWI(iⱼ, db|ⱼ, k). An upper bound value may be used in advance to skip itemsets that have no future without performing subsequent operations of database projection and Mining thereon. Specific operations of a Mining-RHEWI(ij, db|ij, k)′ are shown as algorithm 3.

Algorithm 3: Mining-RHEWI′(X, db|X, k)

Input: X, a prefix itemset; db|X; the projected database by X, a projection sub-
database db|X based on the X itemset; k, the length of X.
Output: The set of RHEWIs with the prefix X
//generate, according to the lexicographical order in the set of the RHEWUBI¹, a
combination of all (k+1)-iternsels using X′ as a reference and merge the
combination with a set PCk + 1. For example, if RHEWUBI¹ = {a, b, c, d, e}, and
X′ is b, PCk + 1 = {bc, bd, be}. ba is not included herein because X′ is used as a
reference and items after X′ are referred to, and ba is processed in the foregoing
combination that uses a as a reference.

| | |
|---|---|
| 1. | generate PCk+1 ← {X′\|X′ = X ∪ {y} ∧ y ∈ RHEWUBI¹ ∧ y is greater than all |
| | items in X according to the lexicographical order}; |
| | //for each (k+1)-itemset X′ in the set PCk + 1, the following operations are |
| | performed: |
| 2. | for each (k+1)-itemset X′ ∈ PCk + 1 do |
| | //if X′ is included in T_{q} and db\|X′ |
| 3. | for each X′ ⊆ T_{q} ∧ T_{q}∈db\|X′ do |
| | //construct, by the database db\|X, a projection sub-database db\|X′ based |
| | on X′ |
| 4. | obtain the projected sub-database db\|X′ of X′; |
| | //simultaneously, calculate a value of an R (T_{q}) of each transaction. |
| 5. | calculate R (T_{q}); |
| | //calculate values of an R (X′), and an expSup (X′) of the itemset X′ |
| 6. | calculate R (X′) and expSup (X′); |
| | //calculate a value of an expWSup (X′) of the itemset X′: expWSup (X′) = w |
| | (X′) × expSup (X′); |
| 7. | calculate expWSup (X′) = w (X′) × expSup (X′); |
| | //if the itemset X′ satisfies a condition expWSup (X′) ≥ α × \|D\|, the |
| | itemset belongs to a recent high expected weighted (k+1)-itemset RHEWI^{k+1} |
| 8. | if expWSup (X′) ≥ α × \|D\| then |
| 9. | RHEWI^{k+1} ← RHEWI^{k+1} ∪ X′; //merge the (k+1)-itemset X′ with the set of |
| | the RHEWI^{k+1} |
| | //call a function Mining-RHEWI′(X′, db\|X′, k), and continuously mine, |
| | based on the projection technology, all extended itemsets that use the X′ as |
| | prefixes |
| 10. | call Mining-RHEWI′ (X′, db\|X′, k +1); |
| 11. | RHEWIs ← [symbol] ₖ RHEWIs ^{k+1}; //merge all (k+1)-itemsets RHEWI^{k+1} that satisfy |
| | the condition |
| 12. | return RHEWIs with the prefix X. //return the set of the RHEWIs based on |
| | the prefix itemset X |

During implementation, the RHEWI-PS model uses a sorted upper-bound downward closure property (SUBDC property) to perform a filtering operation in advance, so as to avoid a large quantity of operations of database projection and mining operation, thereby greatly improving mining performance and ensuring completeness and accuracy of a mining result. The SUBDC property mainly depends on the following three theories and details of the theories are described as follows.

Theory 1: Assume that X^{k} is a k-itemset, a (k-1)-itemset X^{k-1} is a subset of X^{k}, that is, a data item in a subset of an itemset is included by the itemset. In addition, assume that high upper bound expected weighted 1-itemsets within a valid time are sorted in weight-descending order, that is, in weight-descending order of the 1-itemsets. For example, w(i1)≥w(i2)≥≥w(ik)>0. Then w (X^{k})≤w(X^{k-1}) is true. That is, an helmet weight of an itemset is less than or equal to an itemset weight of a subset of the itemset.

For example, in an exemplary database, a sorting result based on weights of all 1 itemset therein in a descending order can be c, e, f, d, b, a. As such, a weight of an itemset (cd) is always not less than a weight of any itemset (cdb), (cda), and (cdba) of the itemset (cd). The weights of the subsets respectively are w (cd)=(1.0+0.55)/2=0.775, w (cdb)=(1.0+0.55+0.4)/3=0.650, w (cda)=(1.0+0.5+0.3)/3=0.600, and w (cdba)=(1.0+0.55+0.4+0.3)/4=0.5625. Therefore, the weight of any itemset (cdb), (cda), and (cdba) is less than or equal to the weight of the itemset (al), which is a subset of itemset (cdb), (cda), or (cdba),

Theory 2: anti-monotonicity always exists in an expSup of an itemset.

That is, assume that X^{k-1} is a (k-1)-itemset, an itemset X^{k} is any superset of X^{k-1}, expSup (X^{k-1})≥expSup (X^{k}) is true. A superset of an itemset is a set that includes all data items of the itemset, that is, a superset of an itemset may include all data items of the itemset and another data item. In other words, an expSup of an itemset is not less than an expSup of a superset of the itemset.

Theory 3: assume that all 1-itemsets are sorted in weight-descending order, that is, in weight-descending order of the 1-itemsets. For example, w (i1)≥w (ii2)≥≥w(ik)>0. Then an expWSup of a k-itemset X is always not less than a value of an expWSup of any superset of the k-itemset X.

That is, assume that X^{k-1} is a (k-1)-itemset, art itemset X^{k} is any superset of X^{k-1}, according to the theory 1 and the theory 2, w (X^{k})≤w (X^{k-1}) and expSup (X^{k-1})≥expSup (X^{k}) are true. Therefore, w (X^{k-1})×expSup (X^{k-1})≥w (X^{k})×expSup (X^{k}), that is, expWSup (X^{k-1})≥expWSup (X^{k}). In other words, an expWSup of an itemset is not less than an expWSup of any superset of the itemset.

According to the theory 3, a core pruning policy as follows may be obtained, that is, a sorted upper-bound downward closure property. In a process of mining operation performed based on the projection technology, when an expWSup of an itemset is less than a predefined minimum expWSup threshold, or when a time validity value is less than a predefined minimum time validity threshold, both the itemset and an extended set of the itemset cannot be an HEWI within a valid time (that is, an RHEWI). In this way, the itemset and the extended set of the itemset can be securely filtered out.

In some embodiments, after the HEWI within a valid time is determined, when content is recommend to a user, the HEWI within a valid time may be recommended.

In some embodiments, after the HEWI within a valid time is determined, an item in the HEWI within a valid time, for example, a web page, news, or a commodity, is pushed to a terminal that logs into a user account of social application software.

In the method for determining an itemset according to this embodiment of the present disclosure, considering that internal uncertainty leads to problems such as an inaccurate determination result and poor timeliness, the HEWI within a valid time is determined in the uncertain database based on multiple measurement standards such as the time-decay factor, the minimum reticency threshold, and a minimum expWSup. Determining of an HEWI within a valid time is enabled to be applicable to an uncertain database. In addition, accuracy and timeliness of an itemset determining result, and determining efficiency are improved. An item is selected from the HEWI within a valid time to be recommended to a user terminal, enabling pushing of information to have accuracy and timeliness.

The following describes an itemset determining apparatus provided by an embodiment of the present disclosure, and cross-reference may be made between the itemset determining apparatus described below and the method for determining an HEWI within a valid time described above accordingly.

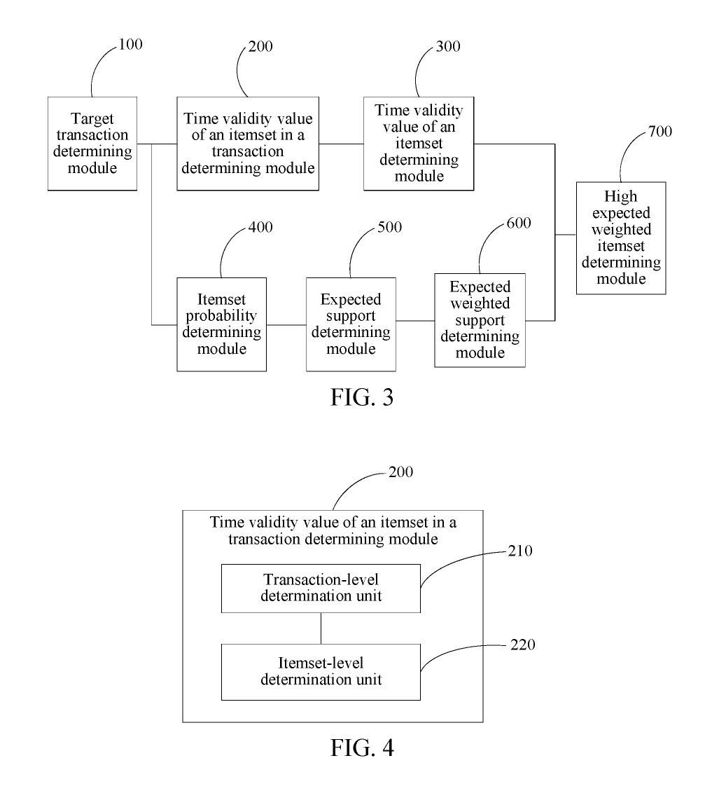

FIG. 3 is a structural block diagram of an itemset determining apparatus according to an embodiment of the present disclosure. Referring to FIG. 3, the apparatus may include various modules that can be in whole or in part implemented according to program instructions executed b a processor, including a target transaction determining module 100, a time validity value of an itemset in a transaction determining module 200, a time validity value of an itemset determining module 300, an itemset probability determining module 400, an expSup determining module 500, an expWSup determining module 600, and an HEWI determining module 700.

The target transaction determining module 100 is configured to determine at least one target transaction corresponding to a candidate itemset, the target transaction corresponding to the candidate itemset being a transaction that comprises all data items of the candidate helmet in an uncertain database.

The time validity value of an itemset in a transaction determining module 200 is configured to determine a time validity value of the candidate itemset in each target transaction based on a predefined time-decay factor.

The time validity value of an itemset determining module 300 is configured to add the time validity values of the candidate itemset in the target transactions, to determine a time validity value of the candidate itemset in the uncertain database.

The itemset probability determining module 400 is configured to determine an itemset probability of the candidate itemset in each target transaction.

The expSup determining module 500 is configured to add the itemset probabilities of the candidate itemset in the target transactions, to determine an expSup of the candidate itemset.

The expWSup determining module 600 is configured to multiply the expSup of the candidate itemset by an itemset weight of the candidate itemset, and to determine an expWSup of the candidate itemset, the itemset weight of the candidate itemset being determined based on predefined weights of the data items in the candidate itemset.

The HEWI determining module 700 is configured to determine that the candidate itemset is an HEWI within a valid time if the time validity value of the candidate itemset in the uncertain database is not less than a predefined minimum time validity threshold and the expWSup of the candidate itemset is not less than a product of a predefined minimum expected weighted threshold and a total quantity of transactions in the uncertain database.

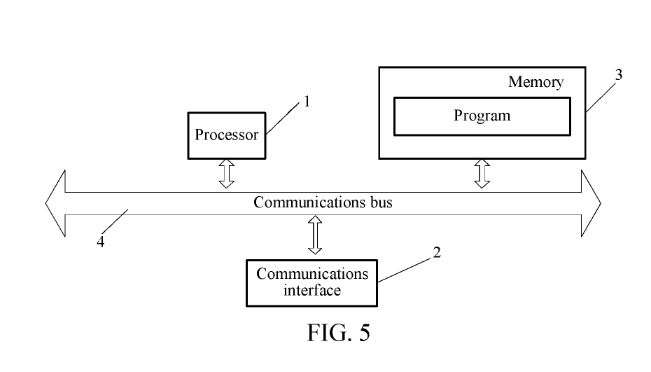

In some embodiments, the time validity value of the candidate itemset in a target transaction may be equal to a time validity value of the target transaction. Correspondingly, FIG. 4 shows an optional structure of the time validity value of an itemset in a transaction determining module 200. Referring to FIG. 4, time validity value of an itemset in a transaction determining module 200 may include a transaction-level determination unit 210 and an itemset-level determination unit 220.

The transaction-level determination unit 210 is configured to respectively determine the time validity value of each target transaction based on the predefined time-decay factor, a current time, and an occurrence time of each target transaction.

The itemset-level determination unit 220 is configured to determine the determined time validity value of each target transaction as the time validity value of the candidate itemset each target transaction.

In some embodiments, the transaction-level determination unit 210 may be specifically configured to determine a time validity value of a target transaction T_{q} according to an equation of

R(T_{q})=(1−δ)^{|t}^{_{current}}^{|-t}^{_{q}}.

where δ∈ (0,1) is the predefined time-decay factor, R(T_{q}) is the time validity value of the target transaction T_{q}, t_{current} represents a current time, and t_{q} represents an occurrence time of the target transaction T_{q}.

In some embodiments, a transaction records at least one data item and an occurrence probability of each data item. The itemset probability determining module 400 may be specifically configured to, for each target transaction, a product of occurrence probabilities of data items of the candidate itemset in the target transaction is used as an itemset probability of the candidate itemset in the target transaction, so as to determine the itemset probability of the candidate itemset in each target transaction.

In some embodiments, when determining the itemset weight, the itemset determining apparatus ma be specifically configured to determine, from a predefined weight table, a weight of each data item of the candidate itemset, and weight corresponding to each data item in the uncertain database is recorded in the weight table; determine a gross weight of data items of the candidate itemset. The itemset determining apparatus may be further configured to obtain the itemset weight of the candidate itemset by dividing the gross weight of data items in the candidate itemset by a quantity of the data items in the candidate itemset.

In some embodiments, the itemset determining apparatus may be further configured to, after one or more high upper bound expected weighted 1-itemsets within a valid time RHEWUBI¹ are mined from one or more 1-itemsets in the database, process, based on a pseudoprojection technology, the one or more high upper bound expected weighted 1-itemsets within a valid time, mine all extended itemsets that use data items thereof as prefixes, and sequentially determine the mined extended itemsets as the candidate itemsets based on a mining time.

In some embodiments, the mined one or more high upper bound expected weighted 1-itemsets within a valid time may be sorted in a lexicographical order, or in a weight-descending order.

Correspondingly, the itemset determining apparatus may determine that an itemset weight of an itemset is not greater than an itemset weight of a subset of the itemset, and a data item in a subset of an itemset is included by the itemset; and/or an expSup of an itemset is not less than an expSup of a superset of the itemset, a superset of an itemset being a set that includes all data items of the itemset; and/or a expWSup of an itemset is not less than an expWSup of a superset of the itemset.

In some embodiments, the itemset determining apparatus may further determine that both an itemset and an extended set of the itemset are not HEWIs within a valid time when an expected weighted support of the itemset is less than the predefined minimum expected weighted threshold, or a time valid value is less than the predefined minimum time valid threshold; and filter the itemset and the extended set of the itemset.

This embodiment of the present disclosure implements determining of an HEWI within a valid time, and not only enables the determining of an HEWI within a valid time to be applicable to the uncertain database, but also improves accuracy, timeliness of a determining result, and mining efficiency.

An embodiment of the present disclosure further provides a processing device which may include the foregoing itemset determining apparatus.

For example, FIG. 5 is a structural block diagram of hardware of a processing device. Referring to FIG. 5, the processing device mar include a processor 1, a communications interface 2, a memory 3, and a communications bus 4.

The processor 1, the communications interface 2, and the memory 3 communicatively coupled with one another through the communications bus 4.

In some embodiments, the communications interface 2 may be an interface of a communications module, for example, an interface of a GSM module.

The processor 1 is configured to execute a program.

The memory 3 is configured to store the program.

The program may include program code, and the program code includes a computer operation instruction.

The processor 1 may be a central processing unit CPU, or an application specific integrated circuit ASIC, or be configured to be one or more integrated circuits for implementing the embodiments of the present disclosure.

The memory 3 may include a high-speed RAM memory, may also include a non-volatile memory, for example, at least one magnetic disk memory in some embodiments, the memory 3 includes a non-transitory computer-readable storage medium.

The program may be specifically used for:

determining at least one target transaction corresponding to a candidate itemset, the target transaction corresponding to the candidate itemset being a transaction that includes all data items of the candidate itemset in an uncertain database;

determining a time validity value of the candidate itemset in each target transaction based on a predefined time-decay factor, and adding the time validity values of the candidate itemset in the target transactions, to determine a time validity value of the candidate itemset in the uncertain database;

determining an itemset probability of the candidate itemset in each target transaction, and adding the itemset probabilities of the candidate itemset in the target transactions, to determine an expSup of the candidate itemset;

multiplying the expSup of the candidate itemset by an itemset weight of the candidate itemset, to determine an expWSup of the candidate itemset, the itemset weight of the candidate itemset being determined based on predefined weights of the data items in the candidate itemset; and

determining that the candidate itemset is an HEWI within a valid time if the time validity value of the candidate itemset in the uncertain database is not less than a predefined minimum time validity threshold and the expWSup of the candidate itemset is not less than a product of a predefined minimum expected weighted threshold and a total quantity of transactions in the uncertain database.

It should be noted that the embodiments in this specification are all described in a progressive manner. Description of each of the embodiments focuses on differences from other embodiments. In the present disclosure, components of various embodiments that are the same or similar may share the same features that only described in one embodiment as an example. The apparatus embodiments are substantially similar to the method embodiments and therefore are only briefly described. For the associated part, refer to the method embodiments.

A person of ordinary skill in the art may understand that, units and algorithm steps of the examples described in the foregoing disclosed embodiments may be implemented by electronic hardware, computer software, or a combination thereof. To clearly describe the interchangeability between the hardware and the software, the foregoing has generally described compositions and steps of each example based on functions. Whether these functions are executed by using the hardware or the software depends on particular application and a designed restriction condition of the technical solution. A person of ordinary skill in the art may use different methods to implement

What is claimed is:

1. An itemset determining method, comprising:
identifying, by a processor, at least one target transaction in a database based on a candidate itemset in the database, the at least one target transaction including each data item in the candidate itemset, and each transaction in the database including at least one data item and an occurrence probability of the data item;
determining, by the processor, a respective first time validity value corresponding to each one of the at least one target transaction based on the candidate itemset and a predefined time-decay factor;
determining, by the processor, a second time validity value of the candidate itemset according to a summation of the respective one or more first time validity values corresponding to the at least one target transaction;
determining, by the processor, a respective itemset probability corresponding to the candidate itemset in each one of the at least one target transaction;
determining an expected support value of the candidate itemset according to a summation of the respective one or more itemset probabilities;
multiplying, by the processor, the expected support value of the candidate itemset by an itemset weight of the candidate itemset, to determine an expected weighted support value of the candidate itemset, the itemset weight of the candidate itemset being determined based on one or more predefined weights of one or more data items in the candidate itemset;
determining, by the processor, that the candidate itemset has a status of a high expected weighted itemset within a valid time when the second time validity value of the candidate itemset is not less than a predefined minimum time validity threshold and the expected weighted support value of the candidate itemset is not less than a product of a predefined minimum expected weighted threshold and a total quantity of transactions in the database; and
performing, by the processor, a data processing on the candidate itemset for output when the candidate itemset is determined as having the status of the high expected weighted itemset within the valid time.

2. The itemset determining method according to claim 1, wherein the determining the respective first time validity value comprises:
respectively determining a third time validity value of each target transaction based on the predefined time-decay factor, a current time, and an occurrence tune of each target transaction; and
setting the determined third time validity value of each target transaction as the first time validity value corresponding to the respective target transaction.

3. The itemset determining method according to claim 2, wherein the respectively determining the third time validity value of each target transaction comprises:
determining a time validity value of a target transaction T_{q} according to an equation of
R(T_{q})=(1−δ)^{|t}^{_{current}}^{|-t}^{_{q}}, wherein
δ∈ (0,1) is the predefined time-decay factor.
R(T_{q}) is the time validity value of the target transaction T_{q},
t_{current} represents the current time, and
t_{q} represents an occurrence time of the target transaction T_{q}.

4. The itemset determining method according to claim wherein the determining the respective itemset probability corresponding to the candidate itemset in each one of the at least one target transaction comprises:
for a particular target transaction, determining the itemset probability based on a product of one or more probabilities that one or more data items of the one of the at least one itemset occur in the particular target transaction,

5. The itemset determining method according to claim 1, further comprising
determining the weights of the data items of the candidate itemset from a predefined weight table, the weight table recording a weight corresponding to each data item in the database;
determining a gross weight of the data items of the candidate itemset; and
dividing the gross weight of the data items of the candidate itemset by a quantity of the data items of the candidate itemset, to obtain the itemset weight of the candidate itemset,

6. The method according to claim further comprising:
identifying one or more 1-item itemsets in the database that have a status of a high upper bound expected weighted itemset within a valid time;
determining one or more extended itemsets that respectively use the identified one or more 1-item itemsets as one or more corresponding prefixes by processing the identified one or more 1-item itemsets that have the status of a high upper bound expected weighted itemset within a valid time, one by one based on a pseudoprojection technology; and
sequentially determining the one or more determined extended itemsets as candidate itemsets based on determining time of the one or more determined extended itemsets,
wherein a particular 1-tem itemset is determined to have the status of the high upper bound expected weighted itemset within the valid time when a time validity value of the particular 1-tem itemset in the database is not less than the predefined minimum time validity threshold and a transaction accumulation upper hound weighted probability of the particular 1-tem itemset is not less than the product of the predefined minimum expected weighted threshold and the total quantity of transactions in the database.

7. The itemset determining method according to claim 6, wherein the identified one or more item itemsets that have the status of the high upper bound expected weighted itemset within the valid time are sorted in a lexicographical order.

8. The itemset determining method according to claim 6, wherein the identified one or more 1-item itemsets that have the status of the high upper bound expected weighted itemset within the valid time are sorted in a weight-descending order.

9. The itemset determining method according to claim 1, wherein
an itemset weight of a particular itemset in the database is not greater than an itemset weight of a subset of the particular itemset, and
each data item in the subset of the particular itemset is included in the particular itemset.

10. The itemset determining method according to claim 1, wherein
an expected support value of a particular itemset in the database is not less than an expected support value of a superset of the particular itemset, and
each data item in the particular itemset is included in the superset of the particular itemset.

11. The itemset determining method according to claim 1, wherein
an expected weighted support value of a particular itemset in the database is not less than an expected weighted support value of a superset of the particular itemset, and
each data item in the itemset is included in the superset of the itemset,

12. The itemset determining method according to claim 1, further comprising:
determining that both a particular itemset in the database and an extended set of the particular itemset do not have the status of the high upper bound expected weighted itemset within the valid time, when an expected weighted support value of the particular itemset is less than the predefined minimum expected weighted threshold or a time validity value of the particular itemset is less than the predefined minimum time validity threshold; and
filtering the particular itemset and the extended set of the particular itemset.

13. The itemset determining method according to claim 1, further comprising:
pushing a data item in the candidate itemset to a terminal that logs into a user account of application software after determining the candidate itemset has the status of the high expected weighted itemset within the valid time.

14. An itemset determining apparatus, comprising:
a memory configured to store processor-executable instructions; and
a processor coupled with the memory and configured to execute the processor-executable instructions to:
identify at least one target transaction in a database based on a candidate itemset the database, the at least one target transaction including each data item in the candidate itemset, and each transaction m the database including at least one data item and an occurrence probability of the data item;
determine a respective first time validity value corresponding to each one of the at least one target transaction based on the candidate itemset and a predefined time-decay factor;
determine a second time validity value of the candidate itemset according to a summation of the respective one or more first time validity values corresponding to the at least one target: transaction;
determine a respective itemset probability corresponding to the candidate itemset in each one of the at least one target transaction;
determine an expected support value of the candidate itemset according to a summation of the respective one or more itemset probabilities;
multiply the expected support value of the candidate itemset by an itemset weight of the candidate itemset, to determine an expected weighted support value of the candidate itemset, the itemset weight of the candidate itemset being determined based on one or more predefined weights of one or more data items in the candidate itemset;
determine that the candidate itemset has a status of a high expected weighted itemset within a valid time when the second time validity value of the candidate itemset is not less than a predefined minimum time validity threshold and the expected weighted support value of the candidate itemset is not less than a product of a predefined minimum expected weighted threshold and a total quantity of transactions in the database; and
perform a data processing on the candidate itemset for output when the candidate itemset is determined as having the status of the high expected weighted itemset within the valid time.

15. The itemset determining apparatus according to claim 14, wherein the processor is configured to:
respectively determine a third time validity value of each target transaction based on the predefined time-decay factor, a current time, and an occurrence time of each target transaction; and
set the determined third time validity value of each target transaction as the first time validity value corresponding to the respective target transaction.

16. The itemset determining apparatus according to claim 14, wherein the processor is configured to:
determine a time validity value of a target transaction T_{q} according to an equation of
R(T_{q})=(1−δ)^{|t}^{_{current}}^{|-t}^{_{q}}, wherein
δ∈ (0,1) is the predefined time-decay factor,
R(T_{q}) is the tithe validity value of the target transaction T_{q},
t_{current} represents the current time, and
t_{q} represents an occurrence time of the target transaction T_{q}.

17. The itemset determining apparatus according to claim 14, wherein the processor is configured to:
identify one or more 1-item itemsets in the database that have a status of a high upper bound expected weighted itemset within a valid time;
determine one or more extended itemsets that respectively use the identified one or more 1-item itemsets as one or more corresponding prefixes by processing the identified one or more 1-item itemsets that have the status of a high upper bound expected weighted itemset within a valid time, one by one based on a pseudoprojection technology; and
sequentially determine the one or more determined extended itemsets as candidate itemsets based on determining time of the one or more determined extended itemsets,
wherein a particular 1-tem itemset is determined to have the status of the high upper bound expected weighted itemset within the valid time when a time validity value of the particular 1-tem itemset in the database is not less than the predefined minimum time validity threshold and a transaction accumulation upper bound weighted probability of the particular 1-tem itemset is not less than the product of the predefined minimum expected weighted threshold and the total quantity of transactions in the database,

18. A non-transitory computer-readable storage medium storing computer-readable instructions, the computer-readable instructions, when executed by a processor, causing the processor to perform:
identifying at least one target transaction in a database based on a candidate itemset in the database, the at least one target transaction including each data item in the candidate itemset, and each transaction in the database including at least one data item and an occurrence probability of the data item;
determining a respective first time validity value corresponding to each one of the at least one target transaction based on the candidate itemset and a predefined time-decay factor,
determining a second time validity value of the candidate itemset according to a summation of the respective one or more first time validity values corresponding to the at least one target transaction;
determining a respective itemset probability corresponding to the candidate itemset in each one of the at least one target transaction:
determining an expected support value of the candidate itemset according to a summation of the respective one or more itemset probabilities;
multiplying the expected support value of the candidate itemset by an itemset weight of the candidate itemset, to determine an expected weighted support value of the candidate itemset, the itemset weight of the candidate itemset being determined based on one or more predefined weights of one or more data items in the candidate itemset;
determining that the candidate itemset has a status of a high expected weighted itemset within a valid time when the second time validity value of the candidate itemset is not less than a predefined minimum time validity threshold and the expected weighted support value of the candidate itemset is not less than a product of a predefined minimum expected weighted threshold and a total quantity of transactions in the database; and
performing a data processing on the candidate itemset for output when the candidate itemset is determined as having the status of the high expected weighted itemset within the valid time.

19. The non-transitory computer-readable storage medium according to claim 18, the stored computer-readable instructions, when executed by the processor, further cause the processor to perform:
determining a time validity value of a target transaction T_{q} according to an equation of
R(T_{q})=(1−δ)^{|t}^{_{current}}^{|-t}^{_{q}}, wherein
δ∈ (0,1) is the predefined time-decay factor,
R(T_{q}) is the time validity value of the target transaction T_{q},
t_{current} represents the current time, and
t_{q} represents an occurrence time of the target transaction T_{q}.

20. The non-transitory computer-readable storage medium according to claim 18, the stored computer-readable instructions, when executed by the processor, further cause the processor to perform
identifying one or more 1-item itemsets in the database that have a status of a high upper bound expected weighted itemset within a valid time,
determining one or more extended itemsets that respectively use the identified one or more 1-item itemsets as one or more corresponding prefixes by processing the identified one or more 1-item itemsets that have the status of a high upper bound expected weighted itemset within a valid time, one by one based on a pseudoprojection technology, and
sequentially determining the one or more determined extended itemsets as candidate itemsets based on determining time of the one or more determined extended itemsets,
wherein a particular 1-tem itemset is determined to have the status of the high upper bound expected weighted itemset within the valid time when a time validity value of the particular 1-tem itemset in the database is not less than the predefined minimum time validity threshold and a transaction accumulation upper bound weighted probability of the particular 1-tem itemset is not less than the product of the predefined minimum expected weighted threshold and the total quantity of transactions in the database.
